(19) United States
(12) Patent Application Publication
(10) Pub. No.: US 2020/0409179 A1
(43) Pub. Date: Dec. 31, 2020

(54) DESIGN STRUCTURE OF REVERSE CURVE OF ORTHOKERATOLOGY LENS

(71) Applicant: BRIGHTEN OPTIX CORP., Taipei (TW)

(72) Inventors: I-Tsung WU, Taipei (TW); Wen-Pin LIN, Taipei (TW)

(21) Appl. No.: 17/022,947

(22) Filed: Sep. 16, 2020

Related U.S. Application Data
(63) Continuation-in-part of application No. 16/158,833, filed on Oct. 12, 2018.
Application No. 16/158,833 is a continuation-in-part of application No. 16/707,519, filed on Dec. 9, 2019.
Application No. 16/707,519 is a continuation of application No. 16/158,833, filed on Oct. 12, 2018.

(30) Foreign Application Priority Data
Nov. 17, 2017 (TW) 106217150

(51) Int. Cl. G02C 7/06; G02C 7/04

(52) U.S. Cl. CPC G02C 7/061; G02C 7/047; G02C 2202/24; G02C 2202/12; G02C 7/041

(57) ABSTRACT

A design structure of a reverse curve of an orthokeratology lens is disclosed. A central part of an inner surface of the orthokeratology lens includes a base curve, and also includes, from the inside to the outside, a reverse curve, an alignment curve and a peripheral curve disposed outside the base curve, and a straight-line distance from the crossover point formed on a junction between the base curve and the reverse curve to the cornea is in a range of 89 μm to 189 μm. Compared with the conventional orthokeratology lens, the orthokeratology lens having the straight-line distance from the crossover point to the cornea in range of 89 μm to 189 μm can provide more peripheral myopic defocus, so as to improve myopia control effect.

This application is a Continuation-In-Part of co-pending application Ser. No. 16/158,833, filed on Oct. 12, 2018, and application Ser. No. 16/707,519, filed on Dec. 9, 2019; and application Ser. No. 16/707,519, filed on Dec. 9, 2019 is a Continuation-In-Part of co-pending application Ser. No. 16/158,833, filed on Oct. 12, 2018; for which priority is claimed under 35 U.S.C. § 120, the entire contents of which are hereby incorporated by reference.

This application claims the priority benefit of application Ser. No. 10/621,7150 filed in Taiwan on Nov. 17, 2017.

### BACKGROUND OF THE INVENTION

### 1. Field of the Invention

The present invention is related to a design structure of a reverse curve of an orthokeratology lens, and more particularly to an orthokeratology lens having a distance, which is from a crossover point formed between a base curve and the reverse curve to a cornea, in a range of 89 μm to 189 μm, so that when an eyelid closed, the orthokeratology lens of the present invention can provide more myopia peripheral defocus than the conventional orthokeratology lens, thereby improving myopia control effect.

### 2. Description of the Related Art

In recent years, with the development and innovation of various electronic products and electrical products, these products bring a lot of convenience to people in daily life and work. In particular, more and more electronic products cause widespread use in communications and Internet applications, so many people (such as office workers, students, middle-aged people, and elderly people) spend a lot of time in the use of electronic products, and such people are usually called as phubbers. However, long-term use of electronic products causes many people's eyes vision loss or damage many people's eyes, and when these conditions are becoming more serious, myopia population also increased rapidly.

Furthermore, the reason why people have myopia is mismatch between the eye's refraction and axial length, for example, when the eye axis is too long or the corneal curvature is too steep, it causes the image focused at a point to fall in front of the retina, so the visual image blurs. Therefore, in order to correct myopia, it is necessary to reduce the eye's refraction, and about 80% of the refraction occurs in the cornea, so reduction of refractive power of the cornea can correct myopia.

The existing methods to correct refractive error mainly include wearing glasses, wearing contact lens, corneal myopia surgery, or wearing an orthokeratology lens. There are advantages and disadvantages of above different methods, and the orthokeratology lens will be especially described in following paragraphs. The orthokeratology lens is made of high oxygen rigid gas permeable material. When the orthokeratology lens is worn on an eyeball, a non-uniform layer of tear is sandwiched between the orthokeratology lens and an outer surface of cornea of the eyeball, and the tear can apply a positive pressure on the cornea to remodeling epithelial cells; at the same time, when the wearer closes the eye wearing the orthokeratology lens, the cornea is applied with a certain pressure by an eyelid and the orthokeratology lens. Therefore, after the wearer wears the lens for a sufficient time, the central curvature of the wearer's cornea can be gradually flattened and central epithelial layer of the wearer's cornea can be gradually thinned, so that the central part of the cornea can be flattened and refractive power of the cornea can be reduced, thereby treating the wearer to correct myopia or even return to normal vision.

However, the orthokeratology lens for controlling myopia is low between 0.50 and 4.00 diopters generally has poor effects on myopia progression. In order to understand the reasons, the experimenters repeated experiments to obtain the experimental data shown in FIG. 4, which is a data diagram of tear thickness analysis in prior art. As shown in FIG. 4, tear thicknesses corresponding to the orthokeratology lenses with curvatures of 39, 42, and 46 for myopia of 500, 700, and 900 degrees are all above 90 μm. Compared with the orthokeratology lens for low myopia, the orthokeratology lens for correcting myopia of 5.00 diopters can provide more myopic defocu, thereby effectively controlling myopia. However, since the base curve of the conventional orthokeratology lens is spherical, the base curve and the reverse curve of the conventional orthokeratology lens for low myopia form insufficient space to accumulate tears, and it causes that the conventional orthokeratology lens for low myopia cannot effectively control myopia.

Therefore, how to solve the above-mentioned conventional problems and inconveniences is a key issue in the industry.

### SUMMARY OF THE INVENTION

In order to solve above-mentioned conventional problems, the inventors develop a design structure of a reverse curve of an orthokeratology lens according to collected data, multiple tests and modifications, and years of experience in the industry.

An objective of the present invention is that a central part of an inner surface of an orthokeratology lens includes a base curve, and the inner surface of the orthokeratology lens also includes, from the inside to the outside, a reverse curve, an alignment curve and a peripheral curve disposed outside the base curve, and the base curve has a central point formed on a central part thereof, and a junction between the base curve and the reverse curve has a crossover point formed thereon, and a straight-line distance from the crossover point to a cornea is in a range of 89 μm to 189 μm; since the straight-line distance from the crossover point to the cornea is in range of 89 μm to 189 μm, the orthokeratology lens of the present invention can provide more peripheral myopic defocus than the conventional orthokeratology lens when the eyelid is closed, thereby achieving the purpose of improving myopia control effect.

Another objective of the present invention is that the base curve of the lens is aspheric to cause a non-zero value of eccentricity of an image shell imaged on retina of the eye ball, to increase a peripheral defocus area imaged on the retina, so as to effectively control axial growth rate, thereby effective controlling myopia to achieve the purpose of correcting myopia.

### BRIEF DESCRIPTION OF THE DRAWINGS

The structure, operating principle and effects of the present invention will be described in detail by way of various embodiments which are illustrated in the accompanying drawings.

FIG. 1 is a sectional side view of an orthokeratology lens of the present invention.

FIG. 2 is a schematic view of optical paths of an orthokeratology lens of the present invention.

FIG. 3 is a data diagram of distance between a cornea and a lens of the present invention.

FIG. 4 is a data diagram of tear thickness analysis in prior art.

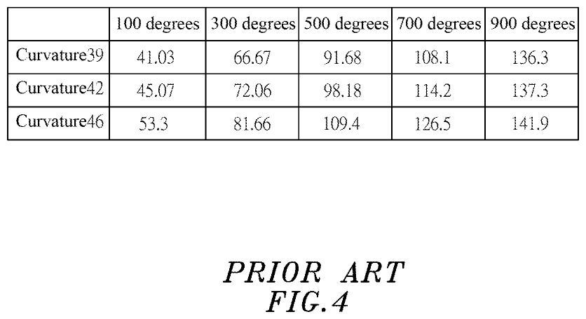

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

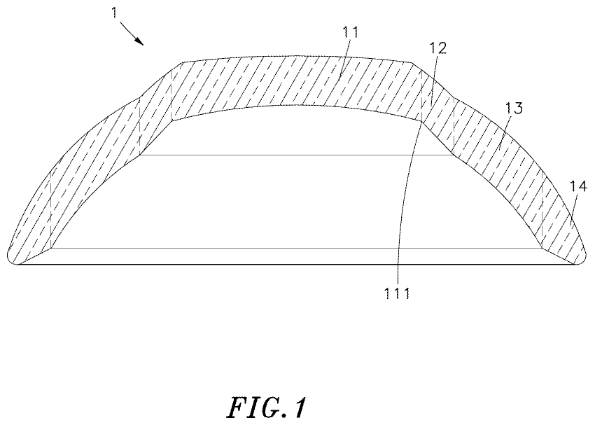

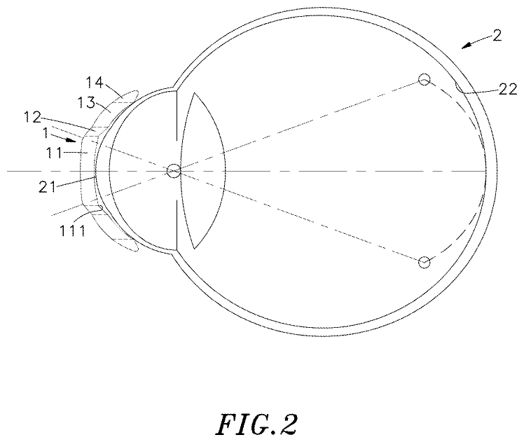

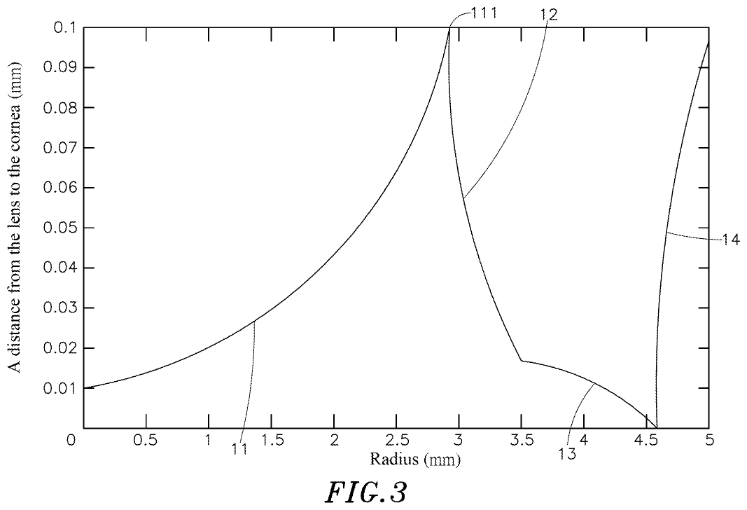

Please refer to FIGS. 1 to 3, which show a sectional side view of an orthokeratology lens of the present invention, a schematic view of optical paths of the orthokeratology lens of the present invention, and a data diagram of distance between the cornea and the orthokeratology lens of the present invention. As shown in FIGS. 1 to 3, the lens 1 can be an orthokeratology lens to be worn on an eye ball 2, and the lens 1 can be in a circular arc shape and made by material with high permeability. The inner surface of the lens 1 can be attached on a surface of a cornea 21 of the eye ball 2, and the lens 1 includes a base curve (BC) 11 disposed on a central part of an inner surface thereof and having eccentricity in range of 0 to 4, and the base curve (BC) 11 can be used to apply a positive pressure on the surface of the cornea 21 by tear (not shown) sandwiched between the lens 1 and the cornea 21. The lens 1 further includes, from the inside to the outside, a reverse curve 12, an alignment curve (AC) 13 and a peripheral curve (PC) 14 disposed outside the base curve 11, and a junction between the base curve 11 and the reverse curve 12 has a crossover point 111 formed thereon, and a straight-line distance from the crossover point 111 between the base curve 11 and the reverse curve 12 to the cornea 21 of the eye ball 2 is in range of 89 μm to 189 μm.

The base curve 11 and the reverse curve 12 of the lens 1 are aspheric, that is, the eccentricity of each of the base curve 11 and the reverse curve 12 is non-zero.

Furthermore, a preset curvature of the base curve 11 of the lens 1 is higher than a horizontal curvature of the cornea 21 of the eye ball 2, that is, the curvature of the base curve 11 is flatter than the horizontal curvature of the cornea 21; since the curvature of the base curve 11 is higher than the curvature of the cornea 21, when the lens 1 is worn on the eye ball 2, a positive pressure can be applied on epithelial cells of the cornea 21 by tear sandwiched between the base curve 11 and the cornea 21. Furthermore, the reverse curve 12 of the lens 1 can be used to store tears, so that a negative pressure applied by the tears can be used to improve effect of aligning the lens 1 on the eye ball 2.

In a preferable design, the peripheral curve 14 of the lens 1 can have a slightly raised edge, so that the lens 1 can facilitate to squeeze out tears during blinking, to promote the tear circulation inside the lens 1, thereby continuously lubricating the contact area between the lens 1 and the cornea 21 of the eye ball 2 and delivering oxygen. Therefore, with the circulation of tears, the orthokeratology lens of the present invention can provide better wearability and comfort in wearing.

During production process of the lens 1 of the present invention, a processing machine can be used to make the eccentricity of the base curve 11 of the lens 1 in a range of 0 to 4, so that the base curve 11 with eccentricity in range of 0 to 4 can be used to make the straight-line distance from the crossover point 111 to the cornea 21 of the eye ball 2 in a range of 89 μm to 189 μm. When wearing the lens of the present invention, a user can wear the lens 1 on the eye ball 2 to make the inner surface of the lens 1 contact the surface of the cornea 21 of the eye ball 2, and at this time, non-uniform thickness of the tear can be sandwiched between the inner surface of the lens 1 and the cornea 21; when the user goes to bed at night and the user's eyelids (not shown) are closed, the eyelid presses the outer surface of the lens 1, weights of the eyelid and the lens 1 can form a positive pressure, and the positive pressure can be applied to epithelial cells of the central part of the surface of the cornea 21 of the eye ball 2 via the tears sandwiched between the base curve 11 of the lens 1 and the cornea 21, so that the central curvature of the epithelial cells of the surface of the cornea 21 gradually becomes flatter subject to pressure applied by the tears, and the central epithelial layer of the cornea 21 becomes thinner to reduce refractive power of the cornea 21 and move the image focal point toward the retina 22 of the eye ball 2, thereby achieving the effect of decreasing degrees of myopia or eliminating degrees of myopia.

Since the straight-line distance from the crossover point 111 between the base curve 11 and the reverse curve 12 to the cornea 21 of the eye ball 2 is in a range of 89 μm to 189 μm, the lens of the present invention can provide more peripheral myopic defocus than the conventional orthokeratology lens when the eyelid is closed, thereby achieving effect of improving myopia control.

Furthermore, the base curve 11 of the lens 1 is aspheric and has non-zero eccentricity, to cause non-zero value of the eccentricity of the image shell imaged on the retina 22 of the eye ball 2, so that the peripheral defocus area imaged on the retina 22 can be increased to effectively control eye axial growth rate, thereby effectively controlling myopia to achieve effect of correcting myopia.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A design structure of the reverse curve of the orthokeratology lens, wherein the orthokeratology lens is applied to be worn on a surface of a cornea of an eye ball, a central part of an inner surface of the orthokeratology lens comprises a base curve with eccentricity in range of 0 to 4, and the orthokeratology lens comprises, from the inside to the outside, a reverse curve, an alignment curve and a peripheral curve disposed outside the base curve, and a junction between the base curve and the reverse curve has a crossover point formed thereon, and a straight-line distance from the cornea of the eye ball to the crossover point between the base curve and the reverse curve is in range of 89 μm to 189 μm.

2. The design structure according to claim 1, wherein the eccentricity of the base curve of the lens is not zero, to cause non-zero value of the eccentricity of an image shell imaged on retina of the eye ball.

3. The design structure according to claim 1, wherein the reverse curve of the lens is aspheric.
